(19) United States
(12) Patent Application Publication
(10) Pub. No.: US 2024/0106927 A1
(43) Pub. Date: Mar. 28, 2024

(54) AUDIO PROCESSING METHOD AND DEVICE

(71) Applicant: HONOR DEVICE CO., LTD., Shenzhen, Guangdong (CN)

(72) Inventor: Chienfeng YEH, Shenzhen (CN)

(21) Appl. No.: 18/270,326

(22) PCT Filed: May 18, 2022
(86) PCT No.: PCT/CN2022/093616

§ 371 Date: Jun. 29, 2023

(30) Foreign Application Priority Data
Jul. 13, 2021 (CN) 202110790588.5

(51) Int. Cl. H04M 1/72454

(52) U.S. Cl. CPC H04M 1/72454

(57) ABSTRACT

Embodiments of this application disclose an audio processing method and device, and relate to the field of electronic devices, to resolve a problem that sound leakage occurs when an earpiece of a mobile phone plays a sound in a quiet environment and sound quality is poor when a sound is produced by a screen. A specific solution is as follows: A first trigger condition is detected, and an earpiece and a screen are controlled, based on a policy corresponding to the first trigger condition, to respectively play sounds in corresponding frequency bands in a sound signal.

This application claims priority to Chinese Patent Application No. 202110790588.5, filed with the China National Intellectual Property Administration on Jul. 13, 2021 and entitled “AUDIO PROCESSING METHOD AND DEVICE”, which is incorporated herein by reference in its entirety.

### TECHNICAL FIELD

Embodiments of this application relate to the field of electronic devices, and in particular, to an audio processing method and device.

### BACKGROUND

Currently, most mobile phones use earpieces disposed at tops of the mobile phones to produce a sound during calls of the mobile phones. Generally, a sound output hole needs to be correspondingly disposed at a location at which the earpiece is disposed in the mobile phone, to release energy generated when the earpiece produces a sound. The sound output hole is usually disposed on a front panel of the mobile phone. However, when the sound output hole is disposed on the front panel of the mobile phone, a width of a frame of the mobile phone increases.

With development of large-screen and full-screen mobile phones, sound output holes of some full-screen mobile phones are designed in a long slot form, and are at locations at which middle frames of the mobile phones are connected to front panels of the mobile phones. In addition, to ensure that a sound output area is large enough to have a good sound output effect, openings are further added to tops of middle frames of some full-screen mobile phones as sound output holes. However, when sound energy of the earpiece comes out from a sound output hole in a shape such as a long slot disposed on the mobile phone or an opening disposed at the top of the middle frame, sound leakage may occur in a quiet environment. In some mobile phones, to avoid sound leakage in a quiet environment, a screen is used instead of an earpiece to produce a sound, but sound quality of the sound produced by the screen is poor and it is difficult to meet a call requirement.

### SUMMARY

Embodiments of this application provide an audio processing method and device, to resolve a problem that sound leakage occurs when an earpiece of a mobile phone plays a sound in a quiet environment and sound quality is poor when a sound is produced by a screen.

To achieve the foregoing objective, the following technical solutions are used in embodiments of this application.

According to a first aspect, an embodiment of this application provides an audio processing method, and the method may be applied to an electronic device. The electronic device may include an earpiece and a screen sound production apparatus, and the screen sound production apparatus is configured to drive a screen to perform screen sound production. The method includes: detecting a first trigger condition; and controlling, based on a policy corresponding to the first trigger condition, the earpiece and the screen to respectively play sounds in corresponding frequency bands in a sound signal.

According to the foregoing technical solution, the electronic device may separately adjust, based on different trigger conditions, frequency bands in which the earpiece and the screen produce a sound, and then play a sound signal by using both the earpiece and the screen, so that earpiece sound production can be complementary to screen sound production, and when playing a sound signal, the electronic device not only can avoid sound leakage in a quiet environment, but also have good sound quality.

In a possible implementation, the first trigger condition includes: the electronic device determines a category of a sound environment in which the electronic device is currently located; and the controlling, based on a policy corresponding to the first trigger condition, the earpiece and the screen to respectively play sounds in corresponding frequency bands in a sound signal includes: controlling, based on the category of the sound environment in which the electronic device is currently located, the earpiece and the screen to respectively play the sounds in the corresponding frequency bands in the sound signal.

In this way, the electronic device may separately adjust, based on determined different categories of the sound environment, frequency bands in which the earpiece and the screen output a sound, to control the earpiece and the screen to respectively play the sounds in the corresponding frequency bands in the sound signal. Therefore, earpiece sound production can be complementary to screen sound production, so that when playing a sound signal, the electronic device not only can avoid sound leakage in a quiet environment, but also have good sound quality.

In another possible implementation, the category of the sound environment includes a quiet environment, a general environment, and a noisy environment.

In another possible implementation, the controlling, based on the category of the sound environment in which the electronic device is currently located, the earpiece and the screen to respectively play the corresponding frequency bands in the sound signal includes: when the category of the sound environment in which the electronic device is currently located is the quiet environment, controlling the earpiece to play a sound in a first frequency band in the sound signal, and controlling the screen to perform screen sound production to play a sound in a second frequency band in the sound signal, where the first frequency band is lower than the second frequency band.

In this way, when in the quiet environment, the electronic device controls the earpiece to play a low-frequency sound, and plays a high-frequency sound through screen sound production. Therefore, screen sound production that has low loudness and that directly faces a human ear plays a high-frequency sound that is sensitive to the human ear to avoid sound leakage, and a low-frequency sound that is insensitive to the human ear is played by using the earpiece to compensate for a low-frequency disadvantage of screen sound production while preventing another user from hearing the sound clearly, thereby improving overall sound quality of a sound played by the electronic device.

In another possible implementation, the controlling, based on the category of the sound environment in which the electronic device is currently located, the earpiece and the screen to respectively play the corresponding frequency bands in the sound signal includes: when the category of the sound environment in which the electronic device is currently located is the general environment, controlling the earpiece to play a sound in a full frequency band in the sound signal, and controlling the screen to perform screen sound production to play a sound in a third frequency band in the sound signal, where the third frequency band corresponds to a frequency band of a frequency response dip of the earpiece.

In this way, when in the general environment, the electronic device controls the earpiece to play the sound in the full frequency band, and plays the sound in the frequency band of the frequency response dip of the earpiece through screen sound production, so that screen sound production can be used to compensate for the frequency response dip of earpiece sound production, thereby improving overall sound quality of a sound played by the electronic device.

In another possible implementation, the controlling, based on the category of the sound environment in which the electronic device is currently located, the earpiece and the screen to respectively play the corresponding frequency bands in the sound signal includes: when the category of the sound environment in which the electronic device is currently located is the noisy environment, controlling the earpiece to play a sound in a full frequency band in the sound signal, and controlling the screen to perform screen sound production to play a sound in a fourth frequency band in the sound signal, where the fourth frequency band is an auditory sensitive frequency band for a human ear.

In this way, when in the noisy environment, the electronic device controls the earpiece to play the sound in the full frequency band, and plays the sound in the auditory sensitive frequency band for a human ear through screen sound production, so that overall volume of the sound in the auditory sensitive frequency band for a human ear can be increased through screen sound production, thereby improving clarity when the electronic device plays a sound.

In another possible implementation, the method further includes: determining the category of the sound environment in which the electronic device is currently located.

In another possible implementation, the determining the category of the sound environment in which the electronic device is currently located includes: detecting volume of an ambient sound in an environment in which the electronic device is currently located; and determining, based on the volume of the ambient sound, the category of the sound environment in which the electronic device is currently located.

In this way, the volume of the ambient sound is detected, and the category of the sound environment is determined based on the volume of the ambient sound, which is relatively simple and easy to implement.

In another possible implementation, the determining, based on the volume of the ambient sound, the category of the sound environment in which the electronic device is currently located includes: when the volume of the ambient sound is greater than a first threshold, determining that the category of the sound environment in which the electronic device is currently located is a noisy environment; when the volume of the ambient sound is greater than a second threshold and less than the first threshold, determining that the category of the sound environment in which the electronic device is currently located is a general environment; and when the volume of the ambient sound is less than the second threshold, determining that the category of the sound environment in which the electronic device is currently located is a quiet environment.

The first threshold and the second threshold may be set based on an actual requirement, that is, a range of the ambient sound volume used to divide different sound environment categories may be set based on an actual requirement.

In another possible implementation, the first trigger condition includes an operation of selecting a category of a sound environment by a user; and the controlling, based on a policy corresponding to the first trigger condition, the earpiece and the screen to respectively play sounds in corresponding frequency bands in a sound signal includes: controlling, based on the category that is of the sound environment and that is selected by the user, the earpiece and the screen to respectively play the sounds in the corresponding frequency bands in the sound signal.

In this way, the electronic device may separately adjust, based on different categories of the sound environment that are selected by the user, frequency bands in which the earpiece and the screen output a sound, to control the earpiece and the screen to respectively play the sounds in the corresponding frequency bands in the sound signal. Therefore, earpiece sound production can be complementary to screen sound production, so that when playing a sound signal, the electronic device not only can avoid sound leakage in a quiet environment, but also have good sound quality.

In another possible implementation, the category of the sound environment includes a quiet environment, a general environment, and a noisy environment.

In another possible implementation, the controlling, based on the category that is of the sound environment and that is selected by the user, the earpiece and the screen to respectively play the sounds in the corresponding frequency bands in the sound signal includes: when the category that is of the sound environment and that is selected by the user is the quiet environment, controlling the earpiece to play a sound in a first frequency band in the sound signal, and controlling the screen to perform screen sound production to play a sound in a second frequency band in the sound signal, where the first frequency band is lower than the second frequency band.

In this way, when the user selects the quiet environment, the electronic device controls the earpiece to play a low-frequency sound, and plays a high-frequency sound through screen sound production. Therefore, screen sound production that has low loudness and that directly faces a human ear plays a high-frequency sound that is sensitive to the human ear to avoid sound leakage, and a low-frequency sound that is insensitive to the human ear is played by using the earpiece to compensate for a low-frequency disadvantage of screen sound production while preventing another user from hearing the sound clearly, thereby improving overall sound quality of a sound played by the electronic device.

In another possible implementation, the controlling, based on the category that is of the sound environment and that is selected by the user, the earpiece and the screen to respectively play the sounds in the corresponding frequency bands in the sound signal includes: when the category that is of the sound environment and that is selected by the user is the general environment, controlling the earpiece to play a sound in a full frequency band in the sound signal, and controlling the screen to perform screen sound production to play a sound in a third frequency band in the sound signal, where the third frequency band corresponds to a frequency band of a frequency response dip of the earpiece.

In this way, when the user selects the general environment, the electronic device controls the earpiece to play the sound in the full frequency band, and plays the sound in the frequency band of the frequency response dip of the earpiece through screen sound production, so that screen sound production can be used to compensate for the frequency response dip of earpiece sound production, thereby improving overall sound quality of a sound played by the electronic device.

In another possible implementation, the controlling, based on the category that is of the sound environment and that is selected by the user, the earpiece and the screen to respectively play the sounds in the corresponding frequency bands in the sound signal includes: when the category that is of the sound environment and that is selected by the user is the noisy environment, controlling the earpiece to play a sound in a full frequency band in the sound signal, and controlling the screen to perform screen sound production to play a sound in a fourth frequency band in the sound signal, where the fourth frequency band is an auditory sensitive frequency band for a human ear.

In this way, when the user selects the noisy environment, the electronic device controls the earpiece to play the sound in the full frequency band, and plays the sound in the auditory sensitive frequency band for a human ear through screen sound production, so that overall volume of the sound in the auditory sensitive frequency band for a human ear can be increased through screen sound production, thereby improving clarity when the electronic device plays a sound.

In another possible implementation, the first trigger condition includes: the electronic device determines volume of an ambient sound in an environment in which the electronic device is currently located; and the controlling, based on a policy corresponding to the first trigger condition, the earpiece and the screen to respectively play sounds in corresponding frequency bands in a sound signal includes: controlling, based on the volume of the ambient sound, the earpiece and the screen to respectively play the sounds in the corresponding frequency bands in the sound signal.

In this way, the electronic device may separately adjust, based on determined different volume of the ambient sound, frequency bands in which the earpiece and the screen output a sound, to control the earpiece and the screen to respectively play the sounds in the corresponding frequency bands in the sound signal. Therefore, earpiece sound production can be complementary to screen sound production, so that when playing a sound signal, the electronic device not only can avoid sound leakage in a quiet environment, but also have good sound quality.

In another possible implementation, the controlling, based on the volume of the ambient sound, the earpiece and the screen to respectively play the sounds in the corresponding frequency bands in the sound signal includes: when the volume of the ambient sound is greater than a first threshold, controlling the earpiece to play a sound in a full frequency band in the sound signal, and controlling the screen to perform screen sound production to play a sound in a fourth frequency band in the sound signal, where the fourth frequency band is an auditory sensitive frequency band for a human ear.

In this way, when the volume of the ambient sound is greater than the first threshold, the earpiece is controlled to play the sound in the full frequency band, and the sound in the auditory sensitive frequency band for a human ear is played through screen sound production, so that overall volume of the sound in the auditory sensitive frequency band for a human ear can be increased through screen sound production, thereby improving clarity when the electronic device plays a sound. In other words, when the volume of the ambient sound is high, overall volume of a played sound can be increased to improve clarity.

In another possible implementation, the controlling, based on the volume of the ambient sound, the earpiece and the screen to respectively play the sounds in the corresponding frequency bands in the sound signal includes: when the volume of the ambient sound is greater than a second threshold and less than the first threshold, controlling the earpiece to play a sound in a full frequency band in the sound signal, and controlling the screen to perform screen sound production to play a sound in a third frequency band in the sound signal, where the third frequency band corresponds to a frequency band of a frequency response dip of the earpiece.

In this way, when the volume of the ambient sound is between the first threshold and the second threshold, the earpiece is controlled to play the sound in the full frequency band, and the sound in the frequency band of the frequency response dip of the earpiece is played through screen sound production, so that screen sound production can be used to compensate for the frequency response dip of earpiece sound production, thereby improving overall sound quality of a sound played by the electronic device. In other words, when the volume of the ambient sound is normal, sound quality of a played sound can be improved.

In another possible implementation, the controlling, based on the volume of the ambient sound, the earpiece and the screen to respectively play the sounds in the corresponding frequency bands in the sound signal includes: when the volume of the ambient sound is less than the second threshold, controlling the earpiece to play a sound in a first frequency band in the sound signal, and controlling the screen to perform screen sound production to play a sound in a second frequency band in the sound signal, where the first frequency band is lower than the second frequency band.

In this way, when the volume of the ambient sound is less than the second threshold, the earpiece is controlled to play a low-frequency sound, and a high-frequency sound is played through screen sound production. Therefore, screen sound production that has low loudness and that directly faces a human ear plays a high-frequency sound that is sensitive to the human ear to avoid sound leakage, and a low-frequency sound that is insensitive to the human ear is played by using the earpiece to compensate for a low-frequency disadvantage of screen sound production while preventing another user from hearing the sound clearly, thereby improving overall sound quality of a sound played by the electronic device. In other words, when the volume of the ambient sound is small, sound leakage can be avoided and sound quality is good.

In another possible implementation, the first trigger condition includes an operation of selecting a listening mode by a user; and the controlling, based on a policy corresponding to the first trigger condition, the earpiece and the screen to respectively play sounds in corresponding frequency bands in a sound signal includes: controlling, based on a category of the listening mode selected by the user, the earpiece and the screen to respectively play the sounds in the corresponding frequency bands in the sound signal.

In this way, the electronic device may separately adjust, based on different listening modes selected by the user, frequency bands in which the earpiece and the screen output a sound, to control the earpiece and the screen to respectively play the sounds in the corresponding frequency bands in the sound signal. Therefore, earpiece sound production can be complementary to screen sound production, so that when playing a sound signal, the electronic device not only can avoid sound leakage in a quiet environment, but also have good sound quality.

In another possible implementation, the listening mode includes a privacy mode, a general mode, and a high-volume mode.

In another possible implementation, the controlling, based on the listening mode selected by the user, the earpiece and the screen to respectively play the sounds in the corresponding frequency bands in the sound signal includes: when the listening mode selected by the user is the privacy mode, controlling the earpiece to play a sound in a first frequency band in the sound signal, and controlling the screen to perform screen sound production to play a sound in a second frequency band in the sound signal, where the first frequency band is lower than the second frequency band.

In this way, when the user selects the privacy mode, the electronic device controls the earpiece to play a low-frequency sound, and plays a high-frequency sound through screen sound production. Therefore, screen sound production that has low loudness and that directly faces a human ear plays a high-frequency sound that is sensitive to the human ear to avoid sound leakage and protect privacy, and a low-frequency sound that is insensitive to the human ear is played by using the earpiece to compensate for a low-frequency disadvantage of screen sound production while preventing another user from hearing the sound clearly, thereby improving overall sound quality of a sound played by the electronic device.

In another possible implementation, the controlling, based on the listening mode selected by the user, the earpiece and the screen to respectively play the sounds in the corresponding frequency bands in the sound signal includes: when the listening mode selected by the user is the general mode, controlling the earpiece to play a sound in a full frequency band in the sound signal, and controlling the screen to perform screen sound production to play a sound in a third frequency band in the sound signal, where the third frequency band corresponds to a frequency band of a frequency response dip of the earpiece.

In this way, when the user selects the general mode, the electronic device controls the earpiece to play the sound in the full frequency band, and plays the sound in the frequency band of the frequency response dip of the earpiece through screen sound production, so that screen sound production can be used to compensate for the frequency response dip of earpiece sound production, thereby improving overall sound quality of a sound played by the electronic device.

In another possible implementation, the controlling, based on the listening mode selected by the user, the earpiece and the screen to respectively play the sounds in the corresponding frequency bands in the sound signal includes: when the listening mode selected by the user is the high-volume mode, controlling the earpiece to play a sound in a full frequency band in the sound signal, and controlling the screen to perform screen sound production to play a sound in a fourth frequency band in the sound signal, where the fourth frequency band is an auditory sensitive frequency band for a human ear.

In this way, when the user selects the high-volume mode, the electronic device controls the earpiece to play the sound in the full frequency band, and plays the sound in the auditory sensitive frequency band for a human ear through screen sound production, so that overall volume of the sound in the auditory sensitive frequency band for a human ear can be increased through screen sound production, thereby improving clarity when the electronic device plays a sound.

In another possible implementation, a frequency of the first frequency band is less than 1 kHz, and a frequency of the second frequency band is greater than 1 kHz.

In another possible implementation, the third frequency band is 1 kHz-2 kHz.

In another possible implementation, the fourth frequency band is 1 kHz-2 kHZ and/or 3 kHZ-4 kHz.

In another possible implementation, before the detecting a first trigger condition, the method further includes: detecting that the electronic device is in an on-ear listening state, or detecting that a user selects an earpiece mode.

In other words, the electronic device performs the method when the electronic device is in the on-ear listening state or the user selects the earpiece mode. The on-ear listening state is a state in which the user's ear approaches the earpiece and the screen for listening.

In another possible implementation, the method further includes: when it is detected that a human ear is away from the electronic device, increasing volume of the sound played by the earpiece and volume of the sound played by the screen, and decreasing an upper limit of the first frequency band that is output through sound production of the earpiece.

In this way, when the human ear is away from the electronic device, the volume may be increased to ensure normal listening of a user. In addition, the upper limit of the frequency band that is output through sound production of the earpiece is decreased, so that the earpiece can play only a sound with a lower frequency, to avoid that sound leakage occurs because the volume of the earpiece is increased and a sound is clearly heard by another user.

In another possible implementation, the sound signal is sound data received when the electronic device performs voice communication, or audio data stored in the electronic device.

In another possible implementation, the first threshold is 70 decibels, and the second threshold is 20 decibels.

According to a second aspect, an embodiment of this application provides an audio processing apparatus, and the apparatus may be applied to an electronic device including an earpiece and a screen sound production apparatus, to implement the method according to the first aspect. A function of the apparatus may be implemented by using hardware, or may be implemented by executing corresponding software by hardware. The hardware or the software includes one or more modules corresponding to the function, for example, a processing module and a detection module.

The detection module may be configured to detect a first trigger condition. The processing module may be configured to: when the first trigger condition is detected, control, based on a policy corresponding to the first trigger condition, the earpiece and a screen to respectively play sounds in corresponding frequency bands in a sound signal.

In a possible implementation, the first trigger condition includes: the electronic device determines a category of a sound environment in which the electronic device is currently located; and the processing module is specifically configured to control, based on the category of the sound environment in which the electronic device is currently located, the earpiece and the screen to respectively play the sounds in the corresponding frequency bands in the sound signal.

In another possible implementation, the category of the sound environment includes a quiet environment, a general environment, and a noisy environment.

In another possible implementation, the processing module is specifically configured to: when the category of the sound environment in which the electronic device is currently located is the quiet environment, control the earpiece to play a sound in a first frequency band in the sound signal, and control the screen to perform screen sound production to play a sound in a second frequency band in the sound signal, where the first frequency band is lower than the second frequency band.

In another possible implementation, the processing module is specifically configured to: when the category of the sound environment in which the electronic device is currently located is the general environment, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module is specifically configured to: when the category of the sound environment in which the electronic device is currently located is the noisy environment, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, the processing module is further configured to determine the category of the sound environment in which the electronic device is currently located.

In another possible implementation, the processing module is specifically configured to: detect volume of an ambient sound in an environment in which the electronic device is currently located; and determine, based on the volume of the ambient sound, the category of the sound environment in which the electronic device is currently located.

In another possible implementation, the processing module is specifically configured to: when the volume of the ambient sound is greater than a first threshold, determine that the category of the sound environment in which the electronic device is currently located is a noisy environment; when the volume of the ambient sound is greater than a second threshold and less than the first threshold, determine that the category of the sound environment in which the electronic device is currently located is a general environment; and when the volume of the ambient sound is less than the second threshold, determine that the category of the sound environment in which the electronic device is currently located is a quiet environment.

The first threshold and the second threshold may be set based on an actual requirement, that is, a range of the ambient sound volume used to divide different sound environment categories may be set based on an actual requirement.

In another possible implementation, the first trigger condition includes an operation of selecting a category of a sound environment by a user; and the processing module is specifically configured to control, based on the category that is of the sound environment and that is selected by the user, the earpiece and the screen to respectively play the sounds in the corresponding frequency bands in the sound signal.

In another possible implementation, the category of the sound environment includes a quiet environment, a general environment, and a noisy environment.

In another possible implementation, the processing module is specifically configured to: when the category that is of the sound environment and that is selected by the user is the quiet environment, control the earpiece to play a sound in a first frequency band in the sound signal, and control the screen to perform screen sound production to play a sound in a second frequency band in the sound signal, where the first frequency band is lower than the second frequency band.

In another possible implementation, the processing module is specifically configured to: when the category that is of the sound environment and that is selected by the user is the general environment, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module is specifically configured to: when the category that is of the sound environment and that is selected by the user is the noisy environment, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, the first trigger condition includes: the electronic device determines volume of an ambient sound in an environment in which the electronic device is currently located; and the processing module is specifically configured to control, based on the volume of the ambient sound, the earpiece and the screen to respectively play the sounds in the corresponding frequency bands in the sound signal.

In another possible implementation, the processing module is specifically configured to: when the volume of the ambient sound is greater than a first threshold, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, the processing module is specifically configured to: when the volume of the ambient sound is greater than a second threshold and less than the first threshold, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module is specifically configured to: when the volume of the ambient sound is less than the second threshold, control the earpiece to play a sound in a first frequency band in the sound signal, and control the screen to perform screen sound production to play a sound in a second frequency band in the sound signal, where the first frequency band is lower than the second frequency band.

In another possible implementation, the first trigger condition includes an operation of selecting a listening mode by a user; and the processing module is specifically configured to control, based on a category of the listening mode selected by the user, the earpiece and the screen to respectively play the sounds in the corresponding frequency bands in the sound signal.

In another possible implementation, the listening mode includes a privacy mode, a general mode, and a high-volume mode.

In another possible implementation, the processing module is specifically configured to: when the listening mode selected by the user is the privacy mode, control the earpiece to play a sound in a first frequency band in the sound signal, and control the screen to perform screen sound production to play a sound in a second frequency band in the sound signal, where the first frequency band is lower than the second frequency band.

In another possible implementation, the processing module is specifically configured to: when the listening mode selected by the user is the general mode, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module is specifically configured to: when the listening mode selected by the user is the high-volume mode, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, a frequency of the first frequency band is less than 1 kHz, and a frequency of the second frequency band is greater than 1 kHz.

In another possible implementation, the third frequency band is 1 kHz-2 kHz.

In another possible implementation, the fourth frequency band is 1 kHz-2 kHZ and/or 3 kHZ-4 kHz.

In another possible implementation, the detection module is further configured to detect that the electronic device is in an on-ear listening state, or detect that a user selects an earpiece mode.

In other words, the electronic device performs the method when the electronic device is in the on-ear listening state or the user selects the earpiece mode. The on-ear listening state is a state in which the user's ear approaches the earpiece and the screen for listening.

In another possible implementation, the processing module is further configured to: when it is detected that a human ear is away from the electronic device, increase volume of the sound played by the earpiece and volume of the sound played by the screen, and decrease an upper limit of the first frequency band that is output through sound production of the earpiece.

In another possible implementation, the sound signal is sound data received when the electronic device performs voice communication, or audio data stored in the electronic device.

In another possible implementation, the first threshold is 70 decibels, and the second threshold is 20 decibels.

According to a third aspect, an embodiment of this application provides an electronic device, including a processor and a memory configured to store instructions executable by the processor. When the processor is configured to execute the instructions, the electronic device is enabled to implement the audio processing method according to any one of the first aspect or the possible implementations of the first aspect.

According to a fourth aspect, an embodiment of this application provides a computer-readable storage medium, where the computer-readable storage medium stores computer program instructions. When the computer program instructions are executed by an electronic device, the electronic device is enabled to implement the audio processing method according to any one of the first aspect or the possible implementations of the first aspect.

According to a fifth aspect, an embodiment of this application provides a computer program product, including computer-readable code. When the computer-readable code is run on an electronic device, the electronic device is enabled to implement the audio processing method according to any one of the first aspect or the possible implementations of the first aspect.

It should be understood that, for beneficial effects of the second aspect to the fifth aspect, refer to related descriptions in the first aspect. Details are not described herein again.

### BRIEF DESCRIPTION OF DRAWINGS

FIG. 1 is a schematic diagram of a structure of an electronic device according to an embodiment of this application;

FIG. 2 is a schematic diagram of a scenario in which a user performs voice communication by using an electronic device according to an embodiment of this application;

FIG. 3 is a schematic diagram of a structure of another electronic device according to an embodiment of this application;

FIG. 4 is a schematic flowchart of an audio processing method according to an embodiment of this application;

FIG. 5A and FIG. 5B are schematic diagrams of interfaces during application of an audio processing method according to an embodiment of this application;

FIG. 6A and FIG. 6B are schematic diagrams of interfaces during application of an audio processing method according to an embodiment of this application;

FIG. 7 is a schematic diagram of a frequency response curve according to an embodiment of this application;

FIG. 8 is a schematic diagram of another interface during application of an audio processing method according to an embodiment of this application;

FIG. 9 is a schematic diagram of another interface during application of an audio processing method according to an embodiment of this application; and

FIG. 10 is a schematic diagram of a structure of an audio processing apparatus according to an embodiment of this application.

### DESCRIPTION OF EMBODIMENTS

Currently, most mobile phones use earpieces disposed at tops of the mobile phones to produce a sound during voice communication of the mobile phones. Generally, a sound output hole needs to be correspondingly disposed at a location of the earpiece, to release energy generated when the earpiece produces a sound. The sound output hole is usually disposed on a front panel of the mobile phone. However, with continuous development of the mobile phone, to provide a user with better screen viewing experience, a screen-to-body ratio of a screen of the mobile phone is increasingly high. Because the sound output hole disposed on the front panel occupies a partial region of the front panel of the mobile phone, a width of a frame of the mobile phone is increased, which affects a further increase in the screen-to-body ratio of the screen of the mobile phone.

Therefore, with development of large-screen and full-screen mobile phones, to reduce an area occupied on the front panel of the mobile phone by the sound output hole of the earpiece (also referred to as a telephone receiver) used to produce a sound during a call in voice communication, to further increase the screen-to-body ratio of the screen, sound output holes of some full-screen mobile phones are designed in a long slot form, and are at locations at which middle frames of the mobile phones are connected to front panels of the mobile phones. In addition, to ensure that a sound output area is large enough to have a good sound output effect, openings are further added to tops of middle frames of some full-screen mobile phones as sound output holes. However, for the sound output hole disposed in this manner, when a user normally uses the mobile phone to perform voice communication, an auricle of the user cannot completely cover the sound output hole. As a result, sound leakage occurs when sound energy of a speaker comes out from the sound output hole disposed at the top of the middle frame of the mobile phone.

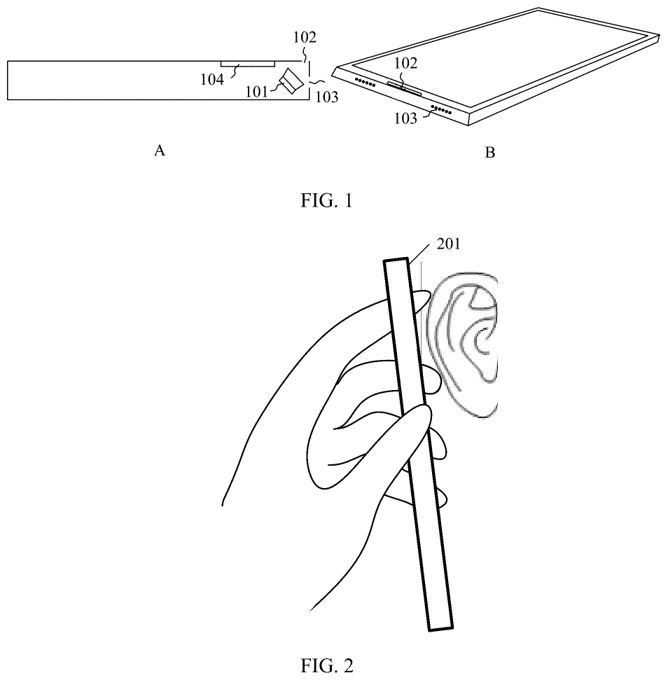

To resolve the foregoing problem, embodiments of this application provide an audio processing method. The method may be applied to an electronic device having a voice communication function. The electronic device may include a screen sound production apparatus (that is, an apparatus that can produce a sound through screen vibration), an earpiece (that is, the foregoing speaker used to produce a sound during a call in voice communication, which is also referred to as a telephone receiver), and a sound output hole disposed corresponding to the earpiece. For example, FIG. 1 is a schematic diagram of a structure of an electronic device according to an embodiment of this application. As shown in FIG. 1, the electronic device may include a front panel (usually including a screen and a frame) configured to dispose a screen, and a rear panel and a middle frame that are configured to support an internal circuit. The front panel, the rear panel, and the middle frame can form a housing structure through enclosure. As shown in A in FIG. 1, an earpiece 101 (that is, a speaker used to produce a sound during a call in voice communication, which is also referred to as a telephone receiver) is disposed at a top location in the housing structure (that is, a top location of the electronic device). Corresponding to the earpiece 101, the electronic device is provided with two sound output holes (for example, a sound output hole 102 and a sound output hole 103). With reference to B in FIG. 1, the sound output hole 102 is at a location (that is, a location of a side slot) at which the front panel and the middle frame of the electronic device are connected. The sound output hole 103 is at a location that is on the middle frame of the electronic device and that is close to the earpiece (that is, a top location of the middle frame of the electronic device). As shown in A in FIG. 1, a screen sound production apparatus 104 (for example, a vibration source connected to a screen) is further disposed in the housing structure formed through enclosure by the front panel, the rear panel, and the middle frame.

For example, the audio processing method may be applied to a scenario in which a user performs on-ear listening by using the electronic device (for example, the user performs voice communication by using the earpiece, and the user listens to a voice message in an instant messaging application by using the earpiece). For example, the electronic device is a mobile phone. FIG. 2 is a schematic diagram of a scenario in which a user performs voice communication by using an electronic device according to an embodiment of this application. As shown in FIG. 2, in a process in which the user holds the mobile phone with a hand to perform voice communication by using an earpiece, a sound output hole 201 of the earpiece of the mobile phone is close to an ear (or an auricle) of the user. The earpiece of the mobile phone is used to play a sound signal of a peer user in a voice communication process (that is, the earpiece of the mobile phone is the foregoing speaker used to produce a sound during a call in voice communication). In this way, because the sound output hole 201 of the earpiece of the mobile phone (such as a sound output hole in a side slot of the mobile phone and a sound output hole at the top of a middle frame) cannot be completely covered by the user's ear, a sound that is output from the sound output hole 201 not only can be heard by the user, but also can be heard by another user in a quiet environment. In some mobile phones, to avoid sound leakage in a quiet environment, a screen is used instead of an earpiece to produce a sound, but sound quality of the sound produced by the screen is poor and it is difficult to meet a call requirement.

Based on this, the audio processing method may include: detecting a first trigger condition; and controlling, based on a policy corresponding to the first trigger condition, an earpiece and a screen to respectively play sounds in corresponding frequency bands in a sound signal. The first trigger condition may be the following: an electronic device determines a category of a sound environment in which the electronic device is currently located, an electronic device determines volume of an ambient sound in an environment in which the electronic device is currently located, an operation of selecting a listening mode by a user, an operation of selecting a category of a sound environment by a user, or the like. For example, the first trigger condition is that an electronic device determines a category of a sound environment in which the electronic device is currently located. When a user performs on-ear listening by using the electronic device, the electronic device may produce a sound by using both an earpiece and a screen; and may separately adjust, based on a category of a listening environment (or referred to as the sound environment, for example, including categories such as a noisy environment, a quiet environment, and a general environment) in which the electronic device is currently located, a frequency band in which the earpiece produces a sound and a frequency band in which the screen produces a sound, that is, control, based on the category of the listening environment in which the electronic device is currently located, the earpiece and the screen to produce a sound to respectively play sounds in corresponding frequency bands in a sound signal.

In this way, the electronic device may separately adjust, based on different listening environments, frequency bands in which the earpiece and the screen produce a sound, and then play a sound signal by using both the earpiece and the screen, so that earpiece sound production can be complementary to screen sound production, and when playing a sound signal, the electronic device not only can avoid sound leakage in a quiet environment, but also have good sound quality. For example, when a sound in a medium-high frequency band in the sound signal is played through screen sound production, the earpiece may play a sound in a medium-low frequency band in the sound signal. The screen is rigid, screen sound production has low loudness and a high frequency, and most energy produces a sound directly facing a human ear. Therefore, when a medium-high frequency sound signal is output through screen sound production, nearby spreading of the medium-high frequency sound signal that is auditory sensitive for a human ear can be reduced, so that the sound signal is not heard by another nearby user, thereby reducing sound leakage. However, there may be a small quantity of low-frequency sounds in screen sound production, and the low-frequency sound is mainly heard by a human ear by relying on bone conduction. Therefore, the low-frequency sound is not heard by another nearby user to avoid sound leakage. A medium-low frequency sound signal is output through earpiece sound production, which can compensate for a low frequency loss when the medium-high frequency sound signal is output through screen sound production, so that a sound signal output by the electronic device as a whole is fuller and has better sound quality. In addition, the human ear is insensitive to perception of the medium-low frequency sound signal. Therefore, when the medium-low frequency sound signal is output through earpiece sound production, after the medium-low frequency sound signal is produced from the sound output hole disposed at the top of the middle frame of the electronic device and spreads to a nearby region, even if the medium-low frequency sound signal is heard by another nearby user, the another user has no strong perception of the medium-low frequency sound signal and it is difficult for the another user to hear the sound signal clearly. Therefore, when the user performs on-ear listening by using the electronic device, the electronic device produces a sound by using both the earpiece and the screen, outputs the medium-high frequency sound signal through screen sound production, and outputs the medium-low frequency sound signal through earpiece sound production. This can better avoid occurrence of sound leakage when the sound output hole of the earpiece is disposed at the top of the middle frame. Therefore, privacy of the user can be well protected, so that the electronic device has better privacy when the user performs on-ear listening.

With reference to the accompanying drawings, the following describes the audio processing method provided in the embodiments of this application.

For example, the electronic device in the embodiments of this application may be a device that has a voice communication function, such as a mobile phone, a tablet computer, an ultra-mobile personal computer (ultra-mobile personal computer, UMPC), a netbook, a cellular phone, a personal digital assistant (personal digital assistant, PDA), or a wearable device (such as a smartwatch or a smart band). A specific form of the electronic device is not specifically limited in the embodiments of this application.

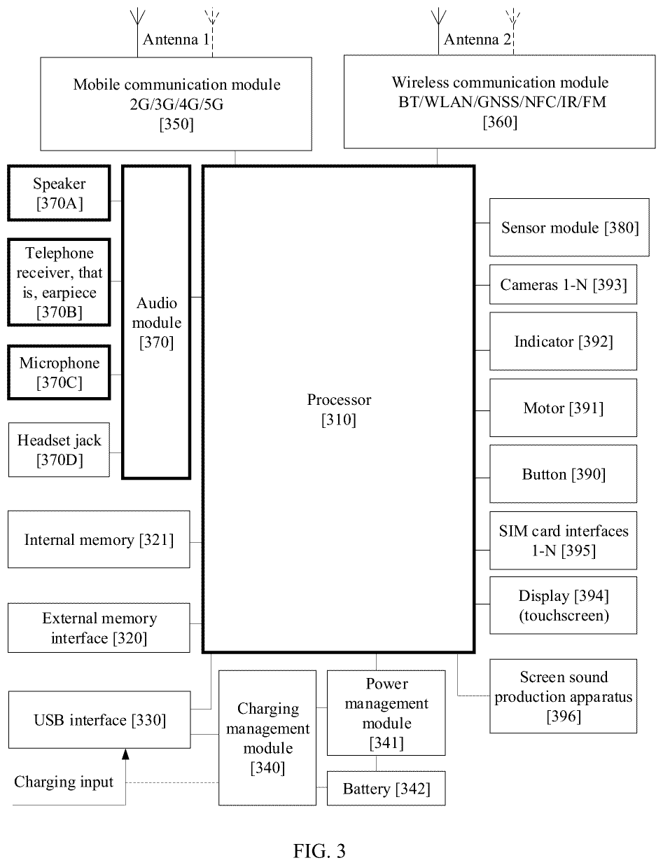

For example, the electronic device is a mobile phone. FIG. 3 is a schematic diagram of a structure of another electronic device according to an embodiment of this application. In other words, for example, the electronic device shown in FIG. 3 can be a mobile phone.

As shown in FIG. 3, the mobile phone may include a processor 310, an external memory interface 320, an internal memory 321, a universal serial bus (universal serial bus, USB) interface 330, a charging management module 340, a power management module 341, a battery 342, an antenna 1, an antenna 2, a mobile communication module 350, a wireless communication module 360, an audio module 370, a speaker 370A, a telephone receiver (that is, an earpiece) 370B, a microphone 370C, a headset jack 370D, a sensor module 380, a button 390, a motor 391, an indicator 392, a camera 393, a display 394, a subscriber identity module (subscriber identification module, SIM) card interface 395, a screen sound production apparatus 396, and the like.

The sensor module may include sensors such as a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, and a bone conduction sensor. In this embodiment of this application, the electronic device may detect, by using a sensor such as the optical proximity sensor (that is, a light sensor) or the distance sensor, whether a user' ear is close to the earpiece. For example, the electronic device may detect, by using the distance sensor, whether there is an obstruction in front of a front panel (or a screen) of the mobile phone, and detect a distance between the obstruction and the screen, to determine whether a user' ear is currently close to the earpiece.

It may be understood that the structure illustrated in this embodiment does not constitute a specific limitation on the mobile phone. In some other embodiments, the mobile phone may include more or fewer components than those shown in the figure, or some components may be combined, or some components may be split, or components are arranged in different manners. The components shown in the figure may be implemented by hardware, software, or a combination of software and hardware.

The processor 310 may include one or more processing units. For example, the processor 310 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, a neural-network processing unit (neural-network processing unit, NPU), and/or the like. Different processing units may be independent components, or may be integrated into one or more processors.

The controller may be a nerve center and a command center of the mobile phone. The controller may generate an operation control signal based on instruction operation code and a time sequence signal, to complete control of instruction fetching and instruction execution.

The memory may be further disposed in the processor 310, and is configured to store instructions and data. In some embodiments, the memory in the processor 310 is a cache. The memory may store instructions or data just used or cyclically used by the processor 310. If the processor 310 needs to use the instructions or the data again, the processor 310 may directly invoke the instructions or the data from the memory. This avoids repeated access and reduces waiting time of the processor 310, thereby improving system efficiency.

In some embodiments, the processor 310 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

It may be understood that an interface connection relationship between the modules illustrated in this embodiment is merely an example for description and does not constitute a limitation on the structure of the mobile phone. In some other embodiments, the mobile phone may alternatively user an interface connection manner different from that in the foregoing embodiment, or user a combination of a plurality of interface connection manners.

In this embodiment of this application, the electronic device may determine, by using the processor 310, a category of a listening environment in which the electronic device is currently located; and then separately adjust, based on the category, a frequency band in which the earpiece produces a sound and a frequency band in which the screen produces a sound, to control the earpiece and the screen to produce a sound to respectively play sounds in corresponding frequency bands in a sound signal, so as to avoid sound leakage of the electronic device when a human ear listens to a sound in a quiet environment.

The charging management module 340 is configured to receive a charging input from a charger (such as a wireless charger or a wired charger) to charge the battery 342. The power management module 341 is configured to connect to the battery 342, the charging management module 340, and the processor 310. The power management module 341 receives an input of the battery 342 and/or an input of the charging management module 340, to supply power to the components in the electronic device.

A wireless communication function of the mobile phone may be implemented by using the antenna 1, the antenna 2, the mobile communication module 350, the wireless communication module 360, the modem processor, the baseband processor, and the like.

The antenna 1 and the antenna 2 are configured to transmit and receive an electromagnetic wave signal. Each antenna in the mobile phone may be configured to cover one or more communication frequency bands. Different antennas may be further multiplexed to improve antenna utilization. For example, the antenna 1 may be multiplexed as a diversity antenna of a wireless local area network. In some other embodiments, the antenna may be used in combination with a tuning switch.

In some embodiments, in the mobile phone, the antenna 1 is coupled to the mobile communication module 350, and the antenna 2 is coupled to the wireless communication module 360, so that the mobile phone can communicate with a network and another device by using a wireless communication technology. The mobile communication module 350 may provide a solution for wireless communication including 2G/3G/4G/5G and the like applied to the mobile phone. The mobile communication module 350 may include at least one filter, a switch, a power amplifier, a low noise amplifier (low noise amplifier, LNA), and the like. The mobile communication module 350 may receive an electromagnetic wave through the antenna 1, perform processing such as filtering or amplification on the received electromagnetic wave, and send a processed electromagnetic wave to the modem processor for demodulation.

The mobile communication module 350 may further amplify a signal modulated by the modem processor, and convert the signal into an electromagnetic wave through the antenna 1 for radiation. In some embodiments, at least some functional modules in the mobile communication module 350 may be disposed in the processor 310. In some embodiments, at least some functional modules in the mobile communication module 350 may be disposed in a same device as at least some modules in the processor 310.

The wireless communication module 360 may provide a solution for wireless communication including a wireless local area network (wireless local area networks, WLAN) (for example, a wireless fidelity (wireless fidelity, Wi-Fi) network), Bluetooth (bluetooth, BT), a global navigation satellite system (global navigation satellite system, GNSS), frequency modulation (frequency modulation, FM), near field communication (near field communication, NFC), an infrared (infrared, IR) technology, and the like applied to the mobile phone.

The wireless communication module 360 may be one or more devices integrating at least one communication processing module. The wireless communication module 360 receives an electromagnetic wave through the antenna 2, modulates and filters an electromagnetic wave signal, and sends a processed signal to the processor 310. The wireless communication module 360 may further receive a to-be-sent signal from the processor 310, perform frequency modulation and amplification on the signal, and convert the signal into an electromagnetic wave through the antenna 2 for radiation.

Certainly, the wireless communication module 360 may also support the mobile phone in performing voice communication. For example, the mobile phone may access a Wi-Fi network by using the wireless communication module 360, and then interact with another device by using any application program that can provide a voice communication service, to provide a user with the voice communication service. For example, the application program that can provide the voice communication service may be an instant messaging application.

The mobile phone may implement a display function by using the GPU, the display 394, the application processor, and the like. The GPU is a microprocessor for image processing, and is connected to the display 394 and the application processor. The GPU is configured to perform mathematical and geometric calculation for graphics rendering. The processor 310 may include one or more GPUs that execute program instructions to generate or change display information. The display 394 is configured to display an image, a video, or the like.

The mobile phone may implement a photographing function by using the ISP, the camera 393, the video codec, the GPU, the display 394, the application processor, and the like. The ISP is configured to process data fed back by the camera 393. In some embodiments, the ISP may be disposed in the camera 393. The camera 393 is configured to capture a still image or a video. In some embodiments, the mobile phone may include one or N cameras 393, where N is a positive integer greater than 1.

The external memory interface 320 may be configured to connect to an external storage card such as a Micro SD card, to extend a storage capability of the mobile phone. The internal memory 321 may be configured to store computer-executable program code, and the executable program code includes instructions. The processor 310 runs the instructions stored in the internal memory 321, to perform various function applications and data processing of the mobile phone. For example, in this embodiment of this application, the processor 310 may execute the instructions stored in the internal memory 321, and the internal memory 321 may include a program storage region and a data storage region.

The mobile phone may implement an audio function, such as music playing or recording, by using the audio module 370, the speaker 370A, the telephone receiver (that is, the earpiece) 370B, the microphone 370C, the headset jack 370D, the application processor, and the like.

The audio module 370 is configured to convert a digital audio signal into an analog audio signal for output, and is also configured to convert an analog audio input into a digital audio signal. The audio module 370 may be further configured to encode and decode an audio signal. In some embodiments, the audio module 370 may be disposed in the processor 310 or some functional modules in the audio module 370 may be disposed in the processor 310. The speaker 370A, also referred to as a “loudspeaker”, is configured to convert an audio electrical signal into a sound signal. The telephone receiver 370B, also referred to as an “earpiece”, is configured to convert an audio electrical signal into a sound signal. The microphone 370C, also referred to as a “mike” or a “mic”, is configured to convert a sound signal into an electrical signal. The headset jack 370D is configured to connect to a wired headset. The headset jack 370D may be the USB interface 330, or may be a 3.5 mm open mobile terminal platform (open mobile terminal platform, OMTP) standard interface or a cellular telecommunications industry association of the USA (cellular telecommunications industry association of the USA, CTIA) standard interface.

The telephone receiver 370B (that is, the “earpiece”) may be the earpiece 101 shown in FIG. 1.

For example, in this embodiment of this application, the audio module 370 may convert audio electrical signals received by the mobile communication module 350 and the wireless communication module 360 into sound signals. The telephone receiver (that is, the “earpiece”) 370B of the audio module 370 plays the sound signal, and the screen sound production apparatus 396 drives the screen (that is, the display) to perform screen sound production to play the sound signal.

For example, in this embodiment of this application, the electronic device may detect, by using the microphone 370C, sound intensity of an ambient sound in an environment in which the electronic device is currently located, so that the processor 310 determines, based on the detected sound intensity of the ambient sound, the category of the listening environment in which the electronic device is currently located.

The button 390 includes a power on/off button, a volume button, and the like. The motor 391 may generate a vibration prompt. The indicator 392 may be an indicator light, which may be configured to indicate a charging state and a power change, or may be configured to indicate a message, a missed call, a notification, or the like. The SIM card interface 395 is configured to connect to a SIM card. The mobile phone may support one or N SIM card interfaces, where N is a positive integer greater than 1.

Certainly, it may be understood that FIG. 3 is merely an example for description when a device form of the electronic device is a mobile phone. If the electronic device is in another device form such as a tablet computer, a handheld computer, a PDA, or a wearable device (for example, a smartwatch or a smart band), the structure of the electronic device may include fewer structures than those shown in FIG. 3 or may include more structures than those shown in FIG. 3. This is not limited herein.

Methods in the following embodiments may all be implemented in an electronic device having the foregoing hardware structure. With reference to the accompanying drawings, the following describes the embodiments of this application by using an example.

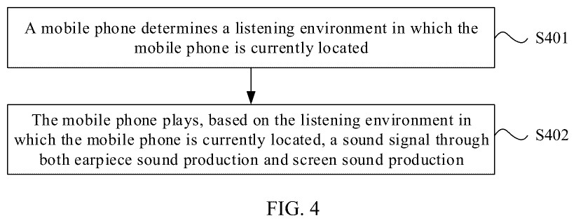

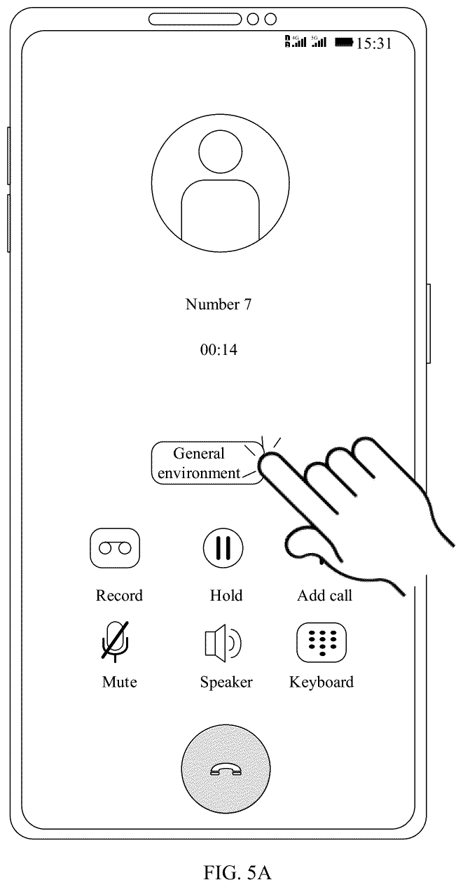

For example, the electronic device is the mobile phone shown in FIG. 1, and a first trigger condition is that an electronic device determines a category of a sound environment in which the electronic device is currently located. FIG. 4 is a schematic flowchart of an audio processing method according to an embodiment of this application. As shown in FIG. 4, the audio processing method may include S401-S402.

When a user performs on-ear listening by using the mobile phone, or the user selects an earpiece mode (that is, a mode in which the mobile phone plays a sound by using an earpiece), the mobile phone may determine a current listening environment, for example, perform the following S401. That the user performs on-ear listening by using the mobile phone (that is, an on-ear listening state in which the mobile phone is located) may be that user's ear is close to the earpiece, and listens, by using the earpiece of the mobile phone, to audio data (such as record data and song data) stored in the mobile phone; or may be that when the user's ear is close to the earpiece to perform voice communication (voice communication may be voice communication performed with another electronic device by using a phone function in the mobile phone, or may be voice communication performed with another electronic device by using an instant messaging application installed in the mobile phone), the user listens, by using the earpiece of the mobile phone, to sound data transmitted from a mobile phone of a peer user and received by the mobile phone; or may be that the user's ear is close to the earpiece to listen to a voice message or the like in an instant messaging application by using the earpiece of the mobile phone. For example, the mobile phone receives a voice message from another mobile phone by using the instant messaging application. The mobile phone may display a chat interface of the instant messaging application, and the chat interface includes a voice message from another mobile phone. In response to an operation of tapping the voice message by the user, the mobile phone may play, by using the earpiece, the voice message (that is, a sound signal) from the another mobile phone.

For example, the mobile phone may detect, by using a sensor such as a light sensor or a distance sensor, whether the user's ear is close to the earpiece. For example, the mobile phone may detect, by using the distance sensor, whether there is an obstruction in front of a front panel (or a screen) of the mobile phone, and when there is an obstruction at a short distance to the front of the front panel, it may be determined that the user's ear is currently close to the earpiece. For another example, when the mobile phone detects, by using the light sensor, that light intensity instantaneously decreases and changes greatly, it may be determined that the user's ear is currently close to the earpiece. Certainly, in another embodiment of this application, the mobile phone may alternatively detect, in another manner or by using an algorithm, whether the user's ear is close to the earpiece. Alternatively, reference may be made to related descriptions in the conventional technology. This is not limited herein.

S401: The mobile phone determines a listening environment in which the mobile phone is currently located (that is, a category of the listening environment).

For example, the category of the listening environment includes a noisy environment, a quiet environment, and a general environment.

In some possible implementations, the noisy environment, the quiet environment, and the general environment may be determined and distinguished by using volume of an ambient sound. For example, the mobile phone may detect the volume of the ambient sound. When the volume of the ambient sound is above a first threshold (for example, 70 decibels), it may be determined that the listening environment in which the mobile phone is currently located is the noisy environment; when the volume of the ambient sound is between a second threshold (for example, 20 decibels) and the first threshold (for example, 70 decibels), it may be determined that the listening environment in which the mobile phone is currently located is the general environment; and when the volume of the ambient sound is below the second threshold (for example, 20 decibels), it may be determined that the listening environment in which the mobile phone is currently located is the quiet environment. When the volume of the ambient sound is the first threshold, it may be determined that the listening environment in which the mobile phone is located is the noisy environment, or it may be determined that the listening environment in which the mobile phone is located is the general environment. When the volume of the ambient sound is the second threshold, it may be determined that the listening environment in which the mobile phone is located is the general environment, or it may be determined that the listening environment in which the mobile phone is located is the quiet environment. This may be set based on an actual situation. In addition, the first threshold is greater than the second threshold.

Certainly, in some other possible implementations, the mobile phone may alternatively determine, in another manner or by using an algorithm, the listening environment in which the mobile phone is currently located. Alternatively, reference may be made to related descriptions in the conventional technology. This is not limited herein.

In some other possible implementations, the mobile phone may alternatively determine, based on user input, the listening environment in which the mobile phone is currently located. To be specific, the user may manually select the listening environment in which the mobile phone is currently located, so that the mobile phone subsequently performs S402 based on the listening environment selected by the user.

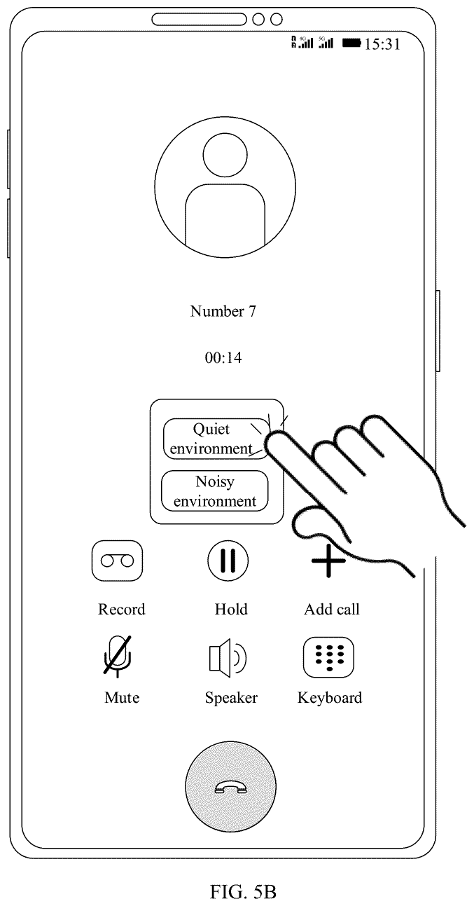

For example, when the user performs on-ear listening by using the mobile phone, the mobile phone may display an interface for the user to select a current listening environment, so that the user selects the current listening environment by using the interface. Optionally, the mobile phone may alternatively determine, by default, that the current listening environment is the general environment. For example, a scenario in which the user performs voice communication (for example, making a call or answering a call) by using the mobile phone is used as an example. As shown in FIG. 5A, a call interface of the mobile phone may display a control indicating a current listening environment. For example, when the current listening environment is the general environment, a control “general environment” is displayed in the call interface of the mobile phone. The user may select the current listening environment by tapping the control used to indicate the current listening environment. For example, when the user taps the control “general environment” shown in FIG. 5A, as shown in FIG. 5B, the mobile phone may display a listening environment list, and the list may include the “quiet environment”, the “noisy environment”, and the like for selection by the user. The user may tap a corresponding listening environment in the listening environment list to select the current listening environment. For example, when the user taps the “quiet environment” shown in FIG. 5B, the mobile phone can switch a category of the current listening environment to the quiet environment, to perform a subsequent step of playing, based on the category of the current listening environment, a sound signal through both the earpiece and screen sound production. In other words, the mobile phone can determine, based on an indication input by the user, that the category of the current listening environment is the quiet environment, to subsequently perform a sound play policy that corresponds to the quiet environment and that is used for the earpiece and the screen produce a sound.

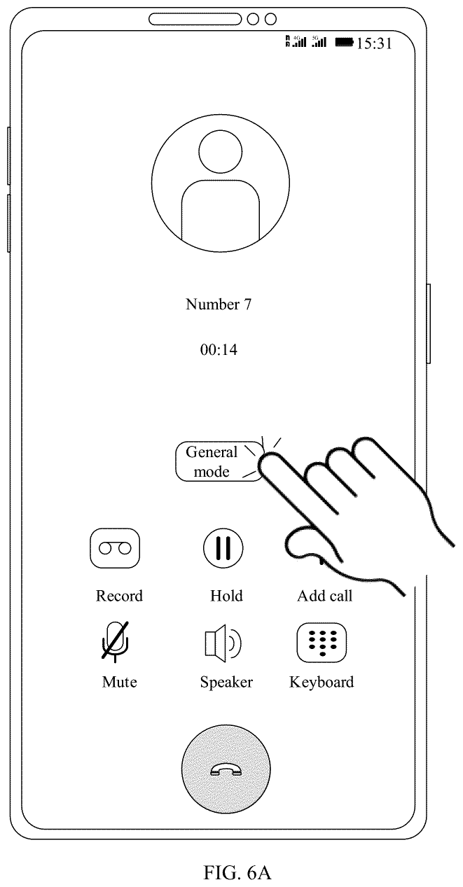

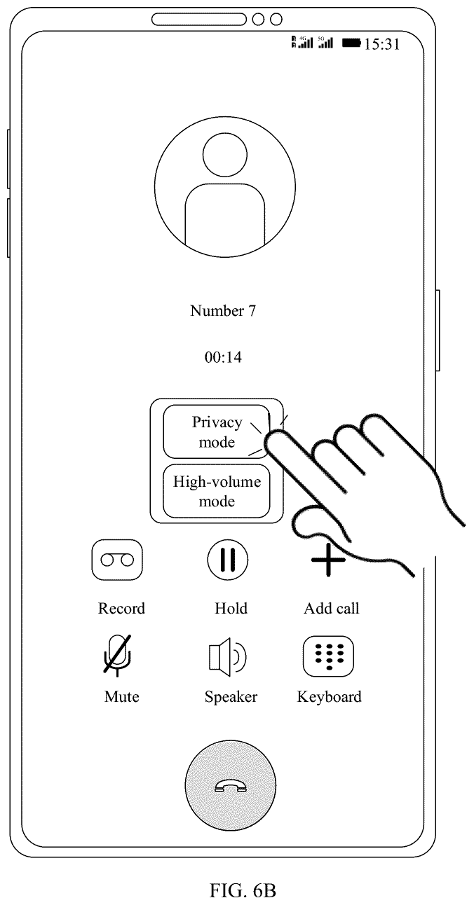

For example, when the user performs on-ear listening by using the mobile phone, the mobile phone may display a listening mode that can be selected by the user. Different listening modes may correspond to the foregoing different listening environment categories. In this way, the user may manually select a listening mode, so that the mobile phone subsequently performs a sound play policy used for the earpiece and the screen to produce a sound. Optionally, the listening mode may include a privacy mode, a general mode, and a high-volume mode. The privacy mode may correspond to the quiet environment, the general mode may correspond to the general environment, and the high-volume mode may correspond to the noisy environment. For example, as shown in FIG. 6A, a call interface of the mobile phone may display a control indicating a current listening mode. For example, when the current listening mode is the general mode, a control “general mode” is displayed in the call interface of the mobile phone. The user may select the current listening mode by tapping the control used to indicate the current listening mode. For example, when the user taps the control “general mode” shown in FIG. 6A, as shown in FIG. 6B, the mobile phone may display a listening mode list, and the list may include other listening modes that can be selected by the user, such as the “privacy mode” and the “high-volume mode”. The user may tap a corresponding listening mode in the listening mode list to select the current listening mode. For example, when the user taps the “privacy mode” shown in FIG. 6B, the mobile phone can switch the current listening mode to the privacy mode. Subsequently, the mobile phone may play, based on a listening environment category corresponding to the listening mode selected by the user, a sound by using a corresponding sound play policy used for the earpiece and the screen to produce a sound.

It should be noted that in the foregoing example, a correspondence between each of different listening modes and a listening environment category may be preset in the mobile phone, so that the mobile phone can determine a corresponding listening environment category based on a listening mode selected by the user corresponding to an operation that is of selecting a listening mode and that is input by the user, and play, based on the determined listening environment category, a sound signal through both earpiece sound production and screen sound production. Alternatively, in the foregoing example, the correspondence between each of different listening modes and a listening environment category may not be preset in the mobile phone, and instead, a sound play policy that is correspondingly used by the mobile phone based on a listening environment category and that is used for the earpiece and the screen to produce a sound directly corresponds to a corresponding listening mode. In this way, after receiving the operation that is of selecting a listening mode and that is input by the user, the mobile phone may directly play a sound by using the corresponding sound play policy used for the earpiece and the screen to produce a sound.

S402: The mobile phone plays, based on the listening environment in which the mobile phone is currently located (that is, the category of the listening environment), a sound signal through both earpiece sound production and screen sound production.

According to various scenarios in which the user performs on-ear listening in the foregoing examples, the sound signal played through the earpiece and screen sound production may be any piece of audio data stored in the mobile phone. For example, the sound signal is record data or song data stored in the mobile phone, or may be sound data transmitted from a mobile phone of a peer user and received by the mobile phone when the mobile phone performs voice communication, or may be a voice message or the like in an instant messaging application installed in the mobile phone.

For example, after determining the listening environment in which the mobile phone is currently located, the mobile phone may set, based on the current listening environment, a frequency (or a frequency band) of earpiece sound production and a frequency (or a frequency band) of screen sound production, and then enable earpiece sound production and screen sound production to separately use different frequency policies to simultaneously play a sound signal. To be specific, the mobile phone may control, based on the category of the listening environment in which the mobile phone is currently located, the earpiece and the screen to respectively play sounds in corresponding frequency bands in a sound signal. In other words, the mobile phone may play a sound based on the category of the listening environment by using a sound play policy that corresponds to the category of the listening environment and that is used for the earpiece and the screen to produce a sound.

For example, when the mobile phone determines that the listening environment in which the mobile phone is currently located is the quiet environment, the mobile phone may perform frequency division through earpiece sound production and screen sound production to simultaneously play a sound signal.

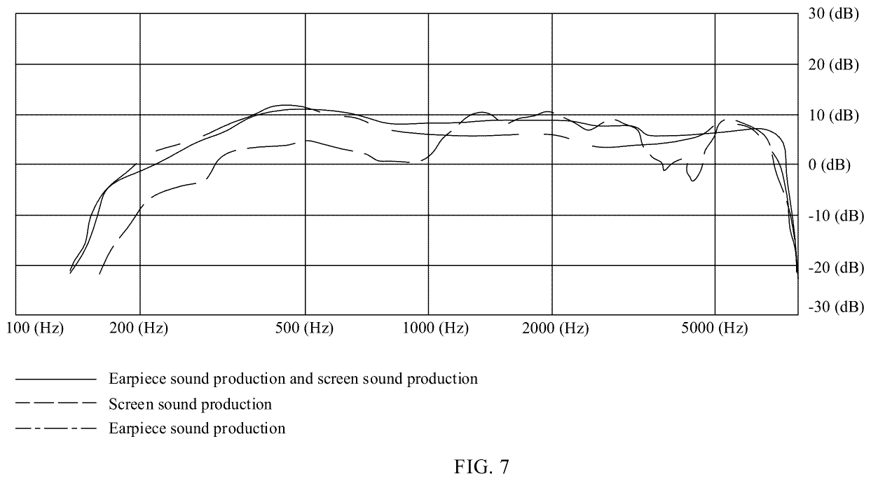

Specifically, when the listening environment is the quiet environment, the mobile phone may play a medium-high frequency (which may also be referred to as a second frequency band in this application) part of the sound signal through screen sound production, and play a medium-low frequency (which may also be referred to as a first frequency band in this application) part of the sound signal by using the earpiece. The medium-high frequency part may be a part whose frequency is greater than 1 kHz in the sound signal, and the medium-low frequency part may be a part whose frequency is less than 1 kHz in the sound signal. A part whose frequency is equal to 1 kHz in the sound signal may be used as the medium-high frequency part, or may be used as the medium-low frequency part. This may be set based on an actual situation. Because loudness of screen sound production is small, when a medium-high frequency sound signal is output through screen sound production, nearby spreading of the medium-high frequency sound signal that is auditory sensitive for a human ear can be reduced, so that the sound signal is not heard by another nearby user, thereby reducing sound leakage. In addition, the medium-high frequency sound signal is output through screen sound production, which may further reduce low-frequency high-impedance pushing of a screen sound production apparatus, and avoid unnecessary power loss. As shown in FIG. 7, based on a frequency response curve of screen sound production, it can be learned that a frequency response of a medium-high frequency of screen sound production is good and a frequency response of a medium-low frequency is poor. Therefore, during screen sound production, a medium-low frequency of a sound is missing and not full. However, based on a frequency response curve of earpiece sound production, it can be learned from that a frequency response of a medium-low frequency of earpiece sound production is good and a frequency response of a medium-high frequency of earpiece sound production is poor. Therefore, when the medium-high frequency sound signal is output through screen sound production, and the medium-low frequency sound signal is output through earpiece sound production, earpiece sound production can compensate for a low frequency loss generated when the medium-high frequency sound signal is output through screen sound production, so that a sound signal output by the electronic device as a whole is fuller and has better sound quality (for example, as shown in FIG. 7, when the medium-high frequency sound signal is output through screen sound production, and the medium-low frequency sound signal is output by using the earpiece, the frequency response curve is flat and has less pits). In addition, the human ear is insensitive to perception of the medium-low frequency sound signal. Therefore, when the medium-low frequency sound signal is output through earpiece sound production, after the medium-low frequency sound signal is produced from the sound output hole disposed at the top of the middle frame of the electronic device and spreads to a nearby region, even if the medium-low frequency sound signal is heard by another nearby user, the another user has no strong perception of the medium-low frequency sound signal and it is difficult for the another user to hear the sound signal clearly.

Optionally, in this embodiment of this application, in the quiet environment, the mobile phone may further adjust volume (or referred to as loudness) of earpiece sound production and screen sound production based on a distance between the human ear and the mobile phone (or the earpiece), and may further adjust a frequency band output through earpiece sound production and a frequency band output through screen sound production. For example, when the human ear is away from the mobile phone, the mobile phone may increase the volume of earpiece sound production and screen sound production. In addition, the mobile phone may further reduce sound production in a high-frequency part in the frequency band output through earpiece sound production, that is, reduce a boundary frequency between the frequency band output through screen sound production and the frequency band output through earpiece sound production, so that a lower frequency band is output through earpiece sound production. Because most of energy generated through screen sound production directly faces the human ear, and some of energy generated through earpiece sound production is released from the sound output hole at the top of the middle frame of the mobile phone, earpiece sound production is more prone to leak a sound than screen sound production after the volume is increased. Therefore, the frequency band output through earpiece sound production is further lowered, so that after the volume is increased, another user can be avoided from clearly hearing a sound output through earpiece sound production.

For example, when the mobile phone determines that the listening environment in which the mobile phone is currently located is the general environment, the mobile phone may simultaneously play a sound signal by primarily using the earpiece and secondarily using screen sound production.

Specifically, when the listening environment is the general environment, the mobile phone may mainly play a sound by using the earpiece, that is, play all frequency bands (that is, a full frequency band) in the sound signal by using the earpiece. However, due to different disposing locations of the earpiece and acoustic structure designs, a frequency response of a sound played by the earpiece may have pits in some frequency bands or at some frequencies. Therefore, screen sound production is secondarily used, to enable the screen to produce a sound to play a sound that is in a sound signal and that corresponds to a frequency band part or frequency part of the frequency response dip of the earpiece (that is, the screen produces a sound to play a sound in a frequency band (or referred to as a third frequency band) that is in the sound signal and that corresponds to the frequency band of the frequency response dip of the earpiece), so that screen sound production can compensate for and optimize the frequency response dip of the earpiece, to improve overall sound quality of the sound signal played by the mobile phone. For example, based on the acoustic structure design, if the frequency band of the frequency response dip of the earpiece is 1 kHz-2 kHz, the screen may be enabled to produce a sound to play some sound signals in the sound signal that correspond to the frequency band of the frequency response dip of the earpiece and whose frequencies fall within 1 kHz-2 kHz.

It should be noted that a frequency response curve of the earpiece may be obtained through debugging at delivery. Therefore, a corresponding sound production frequency band or frequency during screen sound production may be preset based on the frequency response curve of the earpiece. When the mobile phone determines that the current listening environment is the general environment, the mobile phone may control, based on the preset frequency band or frequency, screen sound production to play a sound that is in the sound signal and that corresponds to the corresponding frequency band or frequency.

In this example, to enable the sound signal played through screen sound production to better compensate for the frequency response dip of earpiece sound production, sound intensity of screen sound production may be set based on sensitivity of screen sound production, that is, specified sound intensity of screen sound production may be different based on different sensitivity of screen sound production.

For example, in this embodiment of this application, screen sound production may be implemented by using a screen sound production apparatus (for example, the screen sound production apparatus shown in FIG. 1). The screen sound production apparatus is different based on different screen sound production solutions. For example, the screen sound production apparatus may be a vibration source (which is usually a piezoelectric ceramic, or may be a motor vibrator, an exciter, or another vibration unit) connected to the back of the screen. The piezoelectric ceramic may be controlled to vibrate by using a current signal, to drive the screen to vibrate, so as to implement screen sound production. For another example, the screen sound production apparatus may alternatively be a piezoelectric ceramic that is fastened to the middle frame of the mobile phone by using a cantilever beam structure. The piezoelectric ceramic may be controlled to vibrate by using a current signal, and the vibration is transmitted to the screen by using the middle frame of the mobile phone, to drive the screen to vibrate, so as to implement screen sound production. For another example, the screen sound production apparatus may alternatively be an exciter fastened to the middle frame of the mobile phone. The exciter may be controlled to vibrate by using a current signal, and the vibration is transmitted to the screen by using the middle frame of the mobile phone, to drive the screen to vibrate, so as to implement screen sound production. For another example, the screen sound production apparatus may alternatively be separated magnetic levitation vibrators. One of the vibrators is fastened to the middle frame of the mobile phone, and the other vibrator is fastened to the screen. The vibrator fastened to the screen may be controlled, by using a current signal, to vibrate relative to the vibrator fastened to the middle frame of the mobile phone, so as to push the screen to vibrate to implement screen sound production. Affected by a type and a location set for the screen sound production apparatus, a weight of the middle frame of the mobile phone, an internal structure layout of the mobile phone, and the like, sensitivity of screen sound production in different screen sound production solutions is different. Small sound intensity and pushing power of screen sound production may be set for screen sound production with high sensitivity, and large sound intensity and pushing power of screen sound production may be set for screen sound production with low sensitivity.

For example, when the mobile phone determines that the listening environment in which the mobile phone is currently located is the noisy environment, the mobile phone may simultaneously play a sound signal by primarily using the earpiece and secondarily using screen sound production.

Specifically, when the listening environment is the noisy environment, the mobile phone may mainly play a sound by using the earpiece, that is, play all frequency bands in the sound signal by using the earpiece, and enhance sound intensity generated when the earpiece plays the sound signal (the sound intensity may be enhanced to be greater than sound intensity generated when the earpiece plays the sound signal in the foregoing general environment, so as to resist interference of an ambient sound in the noisy environment in which the mobile phone is located). The mobile phone may play, through screen sound production, a sound in a part that is in the sound signal and that corresponds to an auditory sensitive frequency band for a human ear (for example, a frequency band 1 kHz-2 kHZ and/or a frequency band 3 kHZ-4 kHz) (that is, the mobile phone plays, through screen sound production, a human ear-sensitive sound that is in the sound signal and that is in a key frequency band, that is, the mobile phone plays, through screen sound production, a sound in a fourth frequency band in the sound signal, where the fourth frequency band is an auditory sensitive frequency band for a human ear), so as to improve sound intensity of an auditory sensitive frequency band part for a human ear in a sound played by the mobile phone as a whole, further resist interference of an ambient sound in a noisy environment, and improve on-ear listening experience of a user in the noisy environment.

Optionally, in this embodiment of this application, the electronic device (for example, the mobile phone) may automatically enable the function implemented in the foregoing method, or it may be set that a user manually enables the function implemented in the foregoing method.

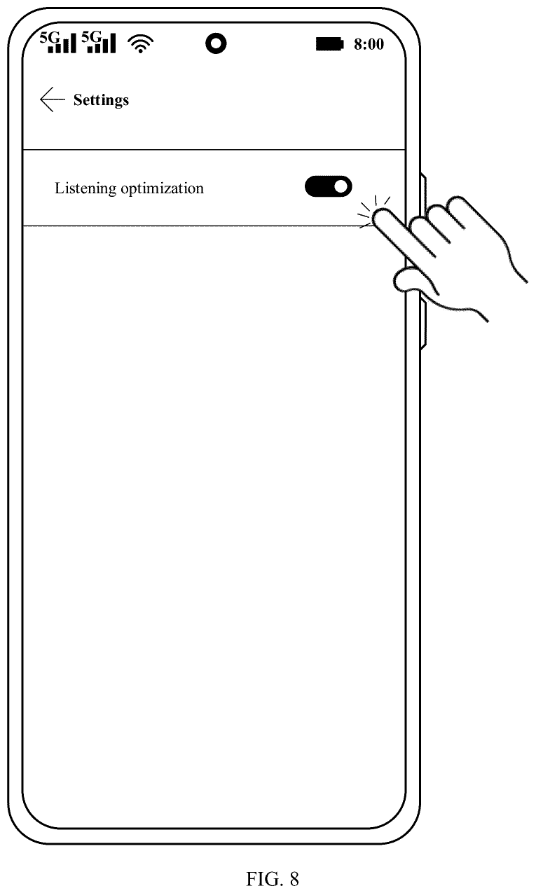

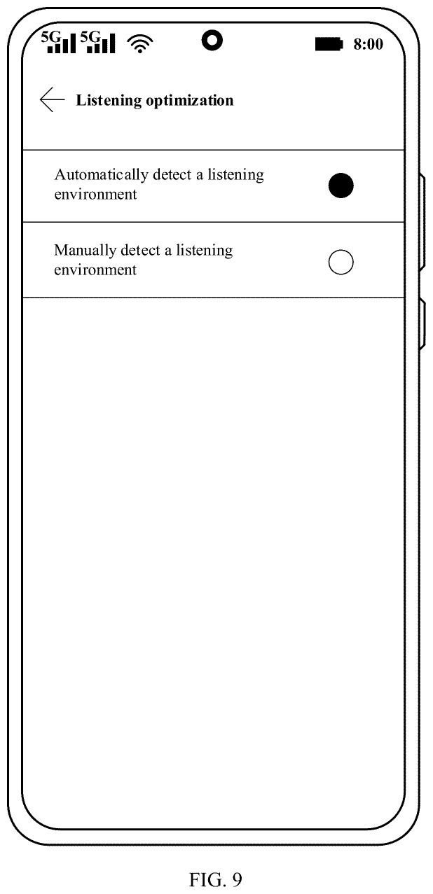

For example, in a settings list, an option for manually enabling the function implemented in the foregoing method may be provided for the user. For example, as shown in FIG. 8, the mobile phone may display a function option “listening optimization” used to enable the foregoing function. When the user taps the function option, the mobile phone can enable the function implemented in the foregoing method, that is, the mobile phone can perform the foregoing method when the user performs on-ear listening.

Optionally, when the mobile phone not only can automatically detect and determine, by using S401 in the method shown in FIG. 4, the listening environment in which the mobile is currently located, but also can determine, in the manner, shown in FIG. 5A and FIG. 5B, in which the user manually select the current listening environment, the listening environment in which the mobile is currently located, as shown in FIG. 8, after the user enables the foregoing function by using the function option that is set in the mobile phone and that is used to enable the function implemented in the foregoing method, the mobile phone may further be used by the user to select whether to automatically detect the current listening environment. For example, after the user taps the function option “listening optimization” shown in FIG. 8, as shown in FIG. 9, the mobile phone may display a function option “automatically detect a listening environment” and a function option “manually select a listening environment”. When the user taps “automatically detect a listening environment”, when performing the method shown in FIG. 4, the mobile phone can automatically detect and determine the listening environment in which the mobile phone is currently located. When the user taps “manually select a listening environment”, when performing the method shown in FIG. 4, the mobile phone can determine, based on a listening environment selected by the user, the listening environment in which the mobile phone is currently located. Optionally, in this case, the mobile phone may display interfaces shown in FIG. 5A and FIG. 5B when the user performs voice communication.

For example, in another embodiment of this application, based on the method shown in FIG. 4, when the mobile phone detects the volume of the ambient sound to determine the category of the sound environment in which the mobile phone is located, the mobile phone may not first determine a corresponding sound environment category based on a range within which the detected volume of the ambient sound falls, and then control the earpiece and screen sound production to respectively play sounds in corresponding frequency bands in a sound signal, but directly control, based on the corresponding range within which the volume of the ambient sound falls (for example, the first threshold and the second threshold enumerated in the method shown in FIG. 4), the earpiece and screen sound production to respectively play the sounds in the corresponding frequency bands in the sound signal. In other words, the first trigger condition is that an electronic device determines volume of an ambient sound in an environment in which the electronic device is currently located. For a specific implementation, refer to the description in the method shown in FIG. 4. Details are not described herein again.

For example, in another embodiment of this application, based on the method shown in FIG. 4, when the user manually selects the category of the sound environment in the manner shown in FIG. 5A and FIG. 5B, the mobile phone may not first determine, based on the category that is of the sound environment and that is selected by the user, the category of the sound environment in which the mobile phone is currently located, and then control the earpiece and screen sound production to respectively play sounds in corresponding frequency bands in a sound signal, but directly control, based on the category that is of the sound environment and that is selected by the user, the earpiece and screen sound production to respectively play the sounds in the corresponding frequency bands in the sound signal. In other words, the first trigger condition is an operation of selecting a category of a sound environment by a user. For a specific implementation, refer to the description in the method shown in FIG. 4. Details are not described herein again.

For example, in another embodiment of this application, based on the method shown in FIG. 4, when the user manually selects the listening mode in the manner shown in FIG. 6A and FIG. 6B, the mobile phone may not first determine, based on the listening mode selected by the user, the category of the sound environment in which the mobile phone is currently located, and then control the earpiece and screen sound production to respectively play sounds in corresponding frequency bands in a sound signal, but directly control, based on the listening mode selected by the user, the earpiece and screen sound production to respectively play the sounds in the corresponding frequency bands in the sound signal. In other words, the first trigger condition is an operation of selecting a listening mode by a user. For a specific implementation, refer to the description in the method shown in FIG. 4. Details are not described herein again.

According to the method in the foregoing embodiment, the electronic device can separately optimize a sound signal play effect in different listening environments, to improve listening experience of a user and avoid sound leakage. For example, in a quiet environment, screen sound production has low loudness and a high frequency, and a human ear mainly listens to a sound through bone conduction. Therefore, when a medium-high frequency sound signal is output through screen sound production, nearby spreading of the medium-high frequency sound signal that is auditory sensitive for a human ear can be reduced, so that the sound signal is not heard by another user, thereby reducing sound leakage. A medium-low frequency sound signal is output through earpiece sound production, which can compensate for a low frequency loss when the medium-high frequency sound signal is output through screen sound production, so that a sound signal output by the electronic device as a whole is fuller and has better sound quality. In addition, the human ear is insensitive to perception of the medium-low frequency sound signal. Therefore, when the medium-low frequency sound signal is output through earpiece sound production, after the medium-low frequency sound signal is produced from the sound output hole disposed at the top of the middle frame of the electronic device and spreads to a nearby region, even if the medium-low frequency sound signal is heard by another nearby user, the another user has no strong perception of the medium-low frequency sound signal and it is difficult for the another user to hear the sound signal clearly. Therefore, when the user performs on-ear listening by using the electronic device, the electronic device produces a sound by using both the earpiece and the screen, outputs the medium-high frequency sound signal through screen sound production, and outputs the medium-low frequency sound signal through earpiece sound production. This can better avoid occurrence of sound leakage when the sound output hole of the earpiece is disposed at the top of the middle frame. Therefore, privacy of the user can be well protected, so that the electronic device has better privacy when the user performs on-ear listening.

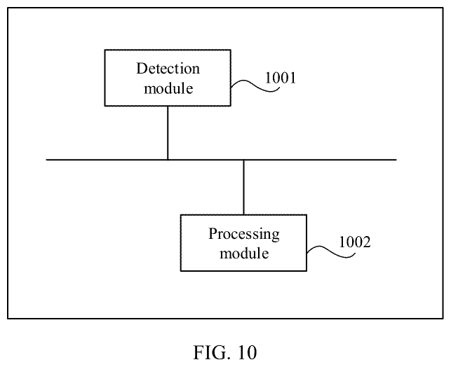

Corresponding to the method in the foregoing embodiment, an embodiment of this application further provides an audio processing apparatus. The apparatus may be applied to the foregoing electronic device to implement the method in the foregoing embodiment. A function of the apparatus may be implemented by using hardware, or may be implemented by executing corresponding software by hardware. The hardware or software includes one or more modules corresponding to the foregoing function. For example, FIG. 10 is a schematic diagram of a structure of an audio processing apparatus. As shown in FIG. 10, the apparatus includes a detection module 1001, a processing module 1002, and the like.

The detection module 1001 may be configured to detect a first trigger condition. The processing module 1002 may be configured to: when the first trigger condition is detected, control, based on a policy corresponding to the first trigger condition, an earpiece and a screen to respectively play sounds in corresponding frequency bands in a sound signal.

In a possible implementation, the first trigger condition includes: an electronic device determines a category of a sound environment in which the electronic device is currently located; and the processing module 1002 is specifically configured to control, based on the category of the sound environment in which the electronic device is currently located, the earpiece and the screen to respectively play the sounds in the corresponding frequency bands in the sound signal.

In another possible implementation, the category of the sound environment includes a quiet environment, a general environment, and a noisy environment.

In another possible implementation, the processing module 1002 is specifically configured to: when the category of the sound environment in which the electronic device is currently located is the quiet environment, control the earpiece to play a sound in a first frequency band in the sound signal, and control the screen to perform screen sound production to play a sound in a second frequency band in the sound signal, where the first frequency band is lower than the second frequency band.

In another possible implementation, the processing module 1002 is specifically configured to: when the category of the sound environment in which the electronic device is currently located is the general environment, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module 1002 is specifically configured to: when the category of the sound environment in which the electronic device is currently located is the noisy environment, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, the processing module 1002 is further configured to determine the category of the sound environment in which the electronic device is currently located.

In another possible implementation, the processing module 1002 is specifically configured to: detect volume of an ambient sound in an environment in which the electronic device is currently located; and determine, based on the volume of the ambient sound, the category of the sound environment in which the electronic device is currently located.

In another possible implementation, the processing module 1002 is specifically configured to: when the volume of the ambient sound is greater than a first threshold, determine that the category of the sound environment in which the electronic device is currently located is a noisy environment; when the volume of the ambient sound is greater than a second threshold and less than the first threshold, determine that the category of the sound environment in which the electronic device is currently located is a general environment; and when the volume of the ambient sound is less than the second threshold, determine that the category of the sound environment in which the electronic device is currently located is a quiet environment.

The first threshold and the second threshold may be set based on an actual requirement, that is, a range of the ambient sound volume used to divide different sound environment categories may be set based on an actual requirement.

In another possible implementation, the first trigger condition includes an operation of selecting a category of a sound environment by a user; and the processing module 1002 is specifically configured to control, based on the category that is of the sound environment and that is selected by the user, the earpiece and the screen to respectively play the sounds in the corresponding frequency bands in the sound signal.

In another possible implementation, the category of the sound environment includes a quiet environment, a general environment, and a noisy environment.

In another possible implementation, the processing module 1002 is specifically configured to: when the category that is of the sound environment and that is selected by the user is the quiet environment, control the earpiece to play a sound in a first frequency band in the sound signal, and control the screen to perform screen sound production to play a sound in a second frequency band in the sound signal, where the first frequency band is lower than the second frequency band.

In another possible implementation, the processing module 1002 is specifically configured to: when the category that is of the sound environment and that is selected by the user is the general environment, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module 1002 is specifically configured to: when the category that is of the sound environment and that is selected by the user is the noisy environment, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, the first trigger condition includes: an electronic device determines volume of an ambient sound in an environment in which the electronic device is currently located; and the processing module 1002 is specifically configured to control, based on the volume of the ambient sound, the earpiece and the screen to respectively play the sounds in the corresponding frequency bands in the sound signal.

In another possible implementation, the processing module 1002 is specifically configured to: when the volume of the ambient sound is greater than a first threshold, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, the processing module 1002 is specifically configured to: when the volume of the ambient sound is greater than a second threshold and less than the first threshold, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module 1002 is specifically configured to: when the volume of the ambient sound is less than the second threshold, control the earpiece to play a sound in a first frequency band in the sound signal, and control the screen to perform screen sound production to play a sound in a second frequency band in the sound signal, where the first frequency band is lower than the second frequency band.

In another possible implementation, the first trigger condition includes an operation of selecting a listening mode by a user; and the processing module 1002 is specifically configured to control, based on a category of the listening mode selected by the user, the earpiece and the screen to respectively play the sounds in the corresponding frequency bands in the sound signal.

In another possible implementation, the listening mode includes a privacy mode, a general mode, and a high-volume mode.

In another possible implementation, the processing module 1002 is specifically configured to: when the listening mode selected by the user is the privacy mode, control the earpiece to play a sound in a first frequency band in the sound signal, and control the screen to perform screen sound production to play a sound in a second frequency band in the sound signal, where the first frequency band is lower than the second frequency band.

In another possible implementation, the processing module 1002 is specifically configured to: when the listening mode selected by the user is the general mode, control the earpiece to play a sound in a full frequency band in the sound signal, and control the screen to perform screen sound production to play a sound in a third frequency band in the sound signal, where the third frequency band corresponds to a frequency band of a frequency response dip of the earpiece.

In another possible implementation, the processing module 1002 is specifically configured to: when the listening mode selected by the user is the high-volume mode, control the earpiece to play a sound in a full frequency band in the sound signal, and control the screen to perform screen sound production to play a sound in a fourth frequency band in the sound signal, where the fourth frequency band is an auditory sensitive frequency band for a human ear.

In another possible implementation, a frequency of the first frequency band is less than 1 kHz, and a frequency of the second frequency band is greater than 1 kHz.

In another possible implementation, the third frequency band is 1 kHz-2 kHz.

In another possible implementation, the fourth frequency band is 1 kHz-2 kHZ and/or 3 kHZ-4 kHz.

In another possible implementation, the detection module 1001 is further configured to detect that an electronic device is in an on-ear listening state, or detect that a user selects an earpiece mode.

In other words, the electronic device performs the method when the electronic device is in the on-ear listening state or the user selects the earpiece mode. The on-ear listening state is a state in which the user's ear approaches the earpiece and the screen for listening.

In another possible implementation, the processing module 1002 is further configured to: when it is detected that a human ear is away from the electronic device, increase volume of the sound played by the earpiece and volume of the sound played by the screen, and decrease an upper limit of the first frequency band that is output through sound production of the earpiece.

In another possible implementation, the sound signal is sound data received when the electronic device performs voice communication, or audio data stored in the electronic device.

In another possible implementation, the first threshold is 70 decibels, and the second threshold is 20 decibels.

It should be understood that division of units or modules (referred to as units in the following) in the apparatus is merely logical function division. In actual implementation, all or some of the units or modules may be integrated into one physical entity, or may be physically separated. In addition, all the units in the apparatus may be implemented in a form of software invoked by a processing element, or may be implemented in a form of hardware; or some units may be implemented in a form of software invoked by a processing element, and some units are implemented in a form of hardware.

For example, the units may be separately disposed processing elements, or may be integrated into a chip in the apparatus for implementation. In addition, the units may be stored in a memory in a form of a program, and invoked by a processing element of the apparatus to implement a function of the unit. In addition, all or some of these units may be integrated together, or may be implemented independently. The processing element described herein may also be referred to as a processor, and may be an integrated circuit that has a signal processing capability. In an implementation process, the steps in the foregoing methods or the foregoing units may be implemented by using a hardware integrated logic circuit in a processor element, or may be implemented in a form of software invoked by the processing element.

In one example, the units in the foregoing apparatus may be one or more integrated circuits configured to implement the foregoing methods, for example, one or more ASICs, one or more DSPs, one or more FPGAs, or a combination of at least two of these integrated circuit forms.

For another example, when the units in the apparatus may be implemented in a form of scheduling a program by using the processing element, the processing element may be a general-purpose processor, for example, a CPU or another processor that can invoke the program. For another example, the units may be integrated together and implemented in a form of a system-on-a-chip (system-on-a-chip, SOC).

In an implementation, the units that are in the foregoing apparatus and that implement corresponding steps in the foregoing methods may be implemented in a form of scheduling a program by using the processing element. For example, the apparatus may include a processing element and a storage element, and the processing element invokes a program stored in the storage element to perform the methods described in the foregoing method embodiments. The storage element may be a storage element that is located on a same chip as the processing element, that is, an on-chip storage element.

In another implementation, the program used to perform the foregoing methods may be on a storage element that is located on a different chip from the processing element, that is, an off-chip storage element. In this case, the processing element invokes or loads the program from the off-chip storage element onto the on-chip storage element, to invoke and perform the methods described in the foregoing method embodiments.

For example, an embodiment of this application may further provide an apparatus such as an electronic device, which may include a processor and a memory configured to store instructions executable by the processor. The processor is configured to enable, when executing the instructions, the electronic device to implement the audio processing method according to the foregoing embodiments. The memory may be located inside the electronic device or may be located outside the electronic device. In addition, there are one or more processors.

In still another implementation, the units that are in the apparatus and that implement the steps in the foregoing methods may be configured as one or more processing elements, and these processing elements may be disposed on the corresponding electronic device described above. The processing elements herein may be integrated circuits, such as one or more ASICs, one or more DSPs, one or more FPGAs, or a combination of these types of integrated circuits. The integrated circuits may be integrated together to form a chip.

For example, an embodiment of this application further provides a chip, and the chip may be applied to the foregoing electronic device. The chip includes one or more interface circuits and one or more processors. The interface circuit and the processor are interconnected by using a line. The processor receives computer instructions from the memory of the electronic device through the interface circuit and executes the computer instructions, to implement the methods described in the foregoing method embodiments.

An embodiment of this application further provides a computer program product, including computer instructions that are run by an electronic device, for example, the foregoing electronic device.

Through the descriptions of the foregoing implementations, a person skilled in the art may clearly understand that, for the purpose of convenient and brief description, only division of the foregoing functional modules is used as an example for description. In actual application, the functions may be allocated to and completed by different functional modules based on a requirement. In other words, an internal structure of the apparatus is divided into different functional modules, to complete all or some of the functions described above.

In the several embodiments provided in this application, it should be understood that the disclosed apparatus and method may be implemented in other manners. For example, the apparatus embodiments described above are merely examples. For example, division of the modules or the units is merely logical function division. In actual implementation, there may be another division manner. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate parts may or may not be physically separate, and parts displayed as units may be one or more physical units, that is, may be located in one place, or may be distributed in a plurality of different places. Some or all of the units may be selected based on actual requirements to achieve the objectives of the solutions in embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the integrated unit may be stored in a readable storage medium. Based on such an understanding, the technical solutions in embodiments of this application essentially, or the part contributing to the conventional technology, or all or some of the technical solutions may be implemented in a form of a software product, for example, a program. The software product is stored in a program product, for example, a computer-readable storage medium, including several instructions for instructing a device (which may be a single-chip microcomputer, a chip, or the like) or a processor (processor) to perform all or some of the steps of the methods in embodiments of this application. The storage medium includes any medium that can store program code, for example, a USB flash drive, a removable hard disk, a ROM, a RAM, a magnetic disk, or an optical disc.

For example, an embodiment of this application may further provide a computer-readable storage medium, and the computer-readable storage medium stores computer program instructions. When the computer program instructions are executed by an electronic device, the electronic device is enabled to implement the audio processing method described in the foregoing method embodiment.

The foregoing descriptions are merely specific implementations of this application, but are not intended to limit the protection scope of this application. Any variation or replacement made within the technical scope disclosed in this application shall fall within the protection scope of this application. Therefore, the protection scope of this application shall be subject to the protection scope of the claims.

What is claimed is:

1. An audio processing method, applied to an electronic device, wherein the electronic device comprises an earpiece and a screen sound production apparatus, and the screen sound production apparatus is configured to drive a screen to perform screen sound production; and the method comprises:
detecting a first trigger condition; and
controlling, based on a policy corresponding to the first trigger condition, the earpiece and the screen to respectively play sounds in corresponding frequency bands in a sound signal.

2. The method according to claim 1, wherein
the first trigger condition comprises: the electronic device determines a category of a sound environment in which the electronic device is currently located; and
the controlling, based on a policy corresponding to the first trigger condition, the earpiece and the screen to respectively play sounds in corresponding frequency bands in a sound signal comprises:
controlling, based on the category of the sound environment in which the electronic device is currently located, the earpiece and the screen to respectively play the sounds in the corresponding frequency bands in the sound signal.

3. The method according to claim 2, wherein the category of the sound environment comprises a quiet environment, a general environment, and a noisy environment.

4. The method according to claim 3, wherein the controlling, based on the category of the sound environment in which the electronic device is currently located, the earpiece and the screen to respectively play the corresponding frequency bands in the sound signal comprises:
when the category of the sound environment in which the electronic device is currently located is the quiet environment, controlling the earpiece to play a sound in a first frequency band in the sound signal, and controlling the screen to perform screen sound production to play a sound in a second frequency band in the sound signal, wherein the first frequency band is lower than the second frequency band.

5. The method according to claim 3, wherein the controlling, based on the category of the sound environment in which the electronic device is currently located, the earpiece and the screen to respectively play the corresponding frequency bands in the sound signal comprises:
when the category of the sound environment in which the electronic device is currently located is the general environment, controlling the earpiece to play a sound in a full frequency band in the sound signal, and controlling the screen to perform screen sound production to play a sound in a third frequency band in the sound signal, wherein the third frequency band corresponds to a frequency band of a frequency response dip of the earpiece.

6. The method according to claim 3, wherein the controlling, based on the category of the sound environment in which the electronic device is currently located, the earpiece and the screen to respectively play the corresponding frequency bands in the sound signal comprises:
when the category of the sound environment in which the electronic device is currently located is the noisy environment, controlling the earpiece to play a sound in a full frequency band in the sound signal, and controlling the screen to perform screen sound production to play a sound in a fourth frequency band in the sound signal, wherein the fourth frequency band is an auditory sensitive frequency band for a human ear.

7. The method according to claim 2, wherein the method further comprises: determining the category of the sound environment in which the electronic device is currently located.

8. The method according to claim 7, wherein the determining the category of the sound environment in which the electronic device is currently located comprises:
detecting volume of an ambient sound in an environment in which the electronic device is currently located; and
determining, based on the volume of the ambient sound, the category of the sound environment in which the electronic device is currently located.

9. The method according to claim 8, wherein the determining, based on the volume of the ambient sound, the category of the sound environment in which the electronic device is currently located comprises:
when the volume of the ambient sound is greater than a first threshold, determining that the category of the sound environment in which the electronic device is currently located is a noisy environment;
when the volume of the ambient sound is greater than a second threshold and less than the first threshold, determining that the category of the sound environment in which the electronic device is currently located is a general environment; and
when the volume of the ambient sound is less than the second threshold, determining that the category of the sound environment in which the electronic device is currently located is a quiet environment.

10. The method according to claim 1, wherein
the first trigger condition comprises an operation of selecting a category of a sound environment by a user; and
the controlling, based on a policy corresponding to the first trigger condition, the earpiece and the screen to respectively play sounds in corresponding frequency bands in a sound signal comprises:
controlling, based on the category that is of the sound environment and that is selected by the user, the earpiece and the screen to respectively play the sounds in the corresponding frequency bands in the sound signal.

11. The method according to claim 10, wherein the category of the sound environment comprises a quiet environment, a general environment, and a noisy environment.

12. The method according to claim 11, wherein the controlling, based on the category that is of the sound environment and that is selected by the user, the earpiece and the screen to respectively play the sounds in the corresponding frequency bands in the sound signal comprises:
when the category that is of the sound environment and that is selected by the user is the quiet environment, controlling the earpiece to play a sound in a first frequency band in the sound signal, and controlling the screen to perform screen sound production to play a sound in a second frequency band in the sound signal, wherein the first frequency band is lower than the second frequency band.

13. The method according to claim 11, wherein the controlling, based on the category that is of the sound environment and that is selected by the user, the earpiece and the screen to respectively play the sounds in the corresponding frequency bands in the sound signal comprises:
when the category that is of the sound environment and that is selected by the user is the general environment, controlling the earpiece to play a sound in a full frequency band in the sound signal, and controlling the screen to perform screen sound production to play a sound in a third frequency band in the sound signal, wherein the third frequency band corresponds to a frequency band of a frequency response dip of the earpiece.

14. The method according to claim 11, wherein the controlling, based on the category that is of the sound environment and that is selected by the user, the earpiece and the screen to respectively play the sounds in the corresponding frequency bands in the sound signal comprises:
when the category that is of the sound environment and that is selected by the user is the noisy environment, controlling the earpiece to play a sound in a full frequency band in the sound signal, and controlling the screen to perform screen sound production to play a sound in a fourth frequency band in the sound signal, wherein the fourth frequency band is an auditory sensitive frequency band for a human ear.

15. The method according to claim 1, wherein
the first trigger condition comprises: the electronic device determines volume of an ambient sound in an environment in which the electronic device is currently located; and
the controlling, based on a policy corresponding to the first trigger condition, the earpiece and the screen to respectively play sounds in corresponding frequency bands in a sound signal comprises:
controlling, based on the volume of the ambient sound, the earpiece and the screen to respectively play the sounds in the corresponding frequency bands in the sound signal.

16. The method according to claim 15, wherein the controlling, based on the volume of the ambient sound, the earpiece and the screen to respectively play the sounds in the corresponding frequency bands in the sound signal comprises:
when the volume of the ambient sound is greater than a first threshold, controlling the earpiece to play a sound in a full frequency band in the sound signal, and controlling the screen to perform screen sound production to play a sound in a fourth frequency band in the sound signal, wherein the fourth frequency band is an auditory sensitive frequency band for a human ear.

17. The method according to claim 15, wherein the controlling, based on the volume of the ambient sound, the earpiece and the screen to respectively play the sounds in the corresponding frequency bands in the sound signal comprises:
when the volume of the ambient sound is greater than a second threshold and less than the first threshold, controlling the earpiece to play a sound in a full frequency band in the sound signal, and controlling the screen to perform screen sound production to play a sound in a third frequency band in the sound signal, wherein the third frequency band corresponds to a frequency band of a frequency response dip of the earpiece.

18. The method according to claim 15, wherein the controlling, based on the volume of the ambient sound, the earpiece and the screen to respectively play the sounds in the corresponding frequency bands in the sound signal comprises:
when the volume of the ambient sound is less than the second threshold, controlling the earpiece to play a sound in a first frequency band in the sound signal, and controlling the screen to perform screen sound production to play a sound in a second frequency band in the sound signal, wherein the first frequency band is lower than the second frequency band.

19.-29. (canceled)

30. An electronic device, comprising:
an earpiece;
a screen sound production apparatus to drive a screen to perform screen sound production;
a processor; and
a memory configured to store instructions, which when executed by the processor, cause the electronic device to perform a method, the method comprising:
detecting a first trigger condition, and
controlling, based on a policy corresponding to the first trigger condition, the earpiece and the screen to respectively play sounds in corresponding frequency bands in a sound signal.

31. A computer program product, comprising computer-readable code, wherein when the computer-readable code is run on an electronic device having an earpiece and a screen sound production apparatus drive a screen to perform screen sound production, the electronic device is enabled to perform a method, the method comprising:
detecting a first trigger condition, and
controlling, based on a policy corresponding to the first trigger condition, the earpiece and the screen to respectively play sounds in corresponding frequency bands in a sound signal.
